(19) United States
(12) Patent Application Publication
(10) Pub. No.: US 2016/0342222 A1
(43) Pub. Date: Nov. 24, 2016

(54) BACKLIT KEYBOARD, BACKLIGHT MODULE AND ASSEMBLY METHOD THEREOF

(71) Applicants: DARFON ELECTRONICS (SUZHOU) CO., LTD., Suzhou (CN); Darfon Electronics Corp., Taoyuan (TW)

(72) Inventors: WEN-MING HSU, New Taipei (TW); HSIN-CHENG HO, Taoyuan (TW); HSIN-HUNG LIU, Taoyuan (TW)

(21) Appl. No.: 15/156,349

(22) Filed: May 17, 2016

(30) Foreign Application Priority Data
May 19, 2015 (TW) 104115958

(51) Int. Cl. G06F 3/02; F21V 8/00

(52) U.S. Cl. CPC G06F 3/0202; G02B 6/0055

(57) ABSTRACT

A backlit keyboard includes a baseplate, a light guide plate, a light source, a reflective layer, and a light mask layer. The light mask layer is disposed between the baseplate and the light guide plate. The edge of the light mask layer forms a U-shaped reflective concave pointing downward and extending around the lateral surface of the light guide plate, and a portion of the lateral surface horizontally projects on the U-shaped reflective concave, thus allowing the U-shaped reflective concave to reflect lights leaving the lateral surface of the light guide plate back to the light guide plate. A backlight module for providing backlights to the backlit keyboard and an assembly method of the backlight module are also provided.

### FIELD OF THE INVENTION

The present invention relates to a backlit keyboard, a backlight module and an assembly method thereof, and more particularly to a backlit keyboard without undesirable illumination at lateral positions, a backlight module for the backlit keyboard, and an assembly method of the backlight module.

### BACKGROUND OF THE INVENTION

Keyboard has been an indispensible computer accessory. Operation of keyboards is often subject to the lighting conditions of the surrounding environment. For example, when operating in a dark environment, keyboard users may have difficulties reading the characters on the keycaps of the keyboard clearly, therefore causing inconvenience in operating the keyboard.

Backlit keyboards have thus been designed with the aim of solving such problem. A backlit keyboard typically utilizes a light source installed inside of the keyboard and a light guide plate as the medium for guiding lights to generate total reflection within the light guide plate and illuminate a plurality of keycaps on top of the light guide plate, thus highlighting the characters on the keycaps while users operating the keyboard in a dark environment. However, lights may leak from the lateral sides of the light guide plate while performing total reflection within the light guide plate, therefore causing undesirable halation at non-keycap areas around the edge of the backlit keyboard. Such halation not only affect the appearance of the keyboard, but also lead to unnecessary light loss from the lateral sides of the keyboard, thus reducing lighting efficiency of the keycaps on the backlit keyboard.

Consequently, it has been a technical challenge in the field to reduce undesirable halation around the edge of backlit keyboards and improve illuminating efficiency of the backlit keyboards.

### BRIEF SUMMARY OF THE INVENTION

Therefore, an embodiment of the present invention provides a backlit keyboard to solve the aforementioned problem. The backlit keyboard includes a baseplate, a light guide plate, a light source, a reflective layer and a light mask layer. The light guide plate is disposed under the baseplate. The light guide plate has a light incident surface, a bottom surface, and a lateral surface. The light source is configured for emitting lights toward the light guide plate, so that the lights enter the light guide plate via the light incident surface and are transmitted through the light guide plate. The reflective layer is disposed under the light guide plate for reflecting lights leaving the bottom surface back to the light guide plate. The light mask layer is disposed between the baseplate and the light guide plate; the light mask layer forms a first reflective concave pointing downward and extending around the lateral surface of the light guide plate, and a portion of the lateral surface horizontally projects on the first reflective concave, thus allowing the first reflective concave to reflect lights leaving the lateral surface of the light guide plate back to the light guide plate.

Another embodiment of the present invention also provides a backlit keyboard. The backlit keyboard includes a plurality of keycaps, a baseplate, a light guide plate, a light source, a reflective layer and a light mask layer. The baseplate includes a peripheral area and a keycap area for disposing the plurality of keycaps. The light guide plate is disposed under the keycap area of the baseplate, and has a light incident surface, a bottom surface, and a lateral surface. An area under the peripheral area of the baseplate and over the lateral surface of the light guide plate forms a light leakage area. The light source is configured for emitting lights toward the light guide plate, so that the lights enter the light guide plate via the light incident surface and are transmitted through the light guide plate to reach the keycap area. The reflective layer is disposed under the light guide plate for reflecting lights leaving the bottom surface back to the light guide plate. The light mask layer is disposed between the baseplate and the light guide plate; the light mask layer forms a first reflective concave pointing downward and extending around the lateral surface of the light guide plate within the light leakage area, and a portion of the lateral surface horizontally projects on the first reflective concave, thus allowing the first reflective concave to reflect lights leaving the lateral surface of the light guide plate back to the light guide plate.

Yet another embodiment of the present invention provides a backlight module for providing backlights to at least one keycap area of a backlit keyboard. The backlight module includes a light guide plate, a light mask layer and a reflective layer. The light guide plate is configured to guide lights received by the light guide plate toward a direction so as to provide the backlights to the keycap area. The light mask layer is disposed on the light guide plate. The reflective layer is disposed under the light guide plate for reflecting lights leaving a bottom surface of the light guide plate back to the light guide plate. An edge of the reflective layer binds with an edge of the light mask layer to form an accommodating space for accommodating the light guide plate. The light mask layer forms a first reflective concave pointing downward and extending toward the reflective layer within the accommodating space, and a portion of the lateral surface horizontally projects on the first reflective concave, thus allowing the first reflective concave to reflect lights leaving the lateral surface of the light guide plate back to the light guide plate.

Yet another embodiment of the present invention provides an assembly method of a backlight module. The method includes the steps of: providing a light guide plate; providing a light mask layer having a first reflective concave around an edge of the light mask layer; providing a reflective layer; binding the light mask layer onto a top surface of the light guide plate and the reflective layer onto a bottom surface of the light guide plate; and binding an edge of the reflective layer with an edge of the light mask layer to form an accommodating space for accommodating the light guide plate, and disposing the first reflective concave of the light mask layer pointing downward and extending around a lateral surface of the light guide plate within the accommodating space.

The backlight module of the backlit keyboard according to the embodiments of the present invention utilizes a reflective concave formed by the light mask layer around the lateral surface of the light guide plate to reflect lights transmitted toward the edges of the reflective layer and the light mask layer back to the light guide plate, therefore preventing light loss from the lateral sides of the backlit keyboard and ensuring the lighting efficiency of the keycaps on the backlit keyboard.

For making the above and other purposes, features and benefits become more readily apparent to those ordinarily skilled in the art, the preferred embodiments and the detailed descriptions with accompanying drawings will be put forward in the following descriptions.

### BRIEF DESCRIPTION OF THE DRAWINGS

The present invention will become more readily apparent to those ordinarily skilled in the art after reviewing the following detailed description and accompanying drawings, in which:

FIG. 1 is a schematic top view of a backlit keyboard according to the first embodiment of the present invention;

FIG. 2 is a schematic exploded view of the backlit keyboard of FIG. 1;

FIG. 3 is a schematic top view of the backlit keyboard according to the second embodiment of the present invention;

FIG. 4 is a schematic top view of the backlit keyboard according to the third embodiment of the present invention;

FIG. 5 is a schematic exploded view of the backlit keyboard of FIG. 4;

FIG. 6 is a schematic cross-sectional view of the backlit keyboard according to the first embodiment of the present invention;

FIG. 7 is a schematic enlarged view of area A of FIG. 6;

FIG. 8 is a schematic cross-sectional view of the backlit keyboard according to the second embodiment of the present invention;

FIG. 9 is a schematic enlarged view of area B of FIG. 8;

FIG. 10 is a schematic cross-sectional view of the backlit keyboard according to the third embodiment of the present invention;

FIG. 11 is a schematic enlarged view of area C of FIG. 10; and

FIG. 12 is a flow chart of an assembly method of the backlight module according to an embodiment of the present invention.

### DETAILED DESCRIPTION OF THE INVENTION

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

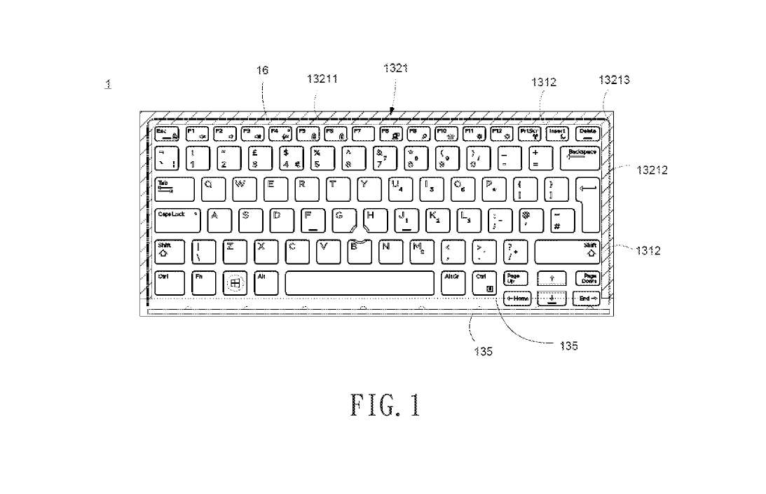

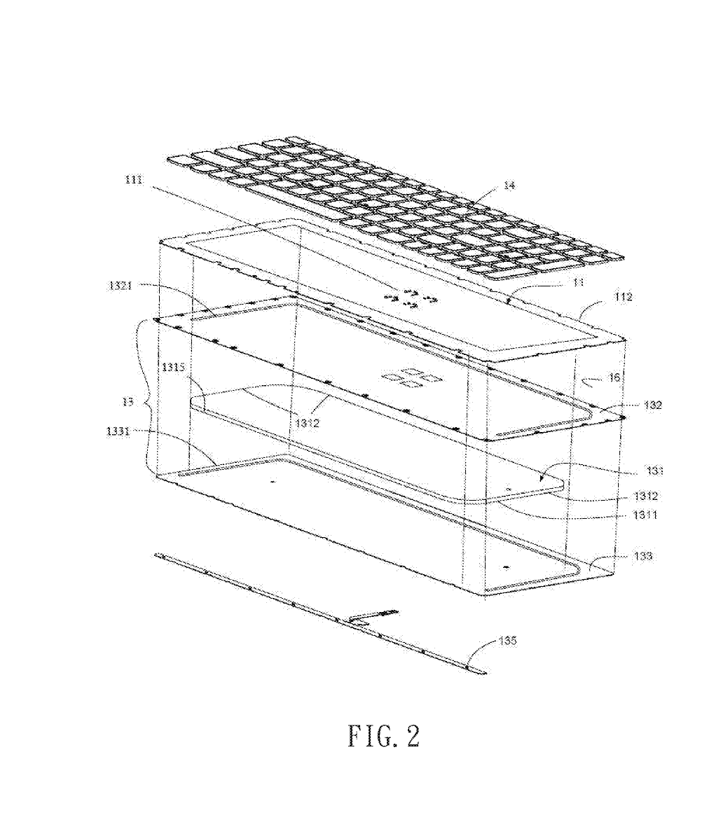

Referring now to FIG. 1 and FIG. 2. The backlit keyboard 1 includes a baseplate 11, a backlight module 13 and a plurality of keycaps 14. The baseplate 11 includes at least one keycap area 111 and a peripheral area 112. A plurality of keycaps 14 are disposed on the keycap area 111.

The backlight module 13 includes a light source 135, a light guide plate 131, a light mask layer 132 and a reflective layer 133. The light guide plate 131 is disposed under the keycap area 111 and within the peripheral area 112 of the baseplate 11, and has a light incident surface 1315, a bottom surface 1311, and at least one lateral surface 1312. An area under the peripheral area 112 of the baseplate 11 and over the lateral surface 1312 of the light guide plate 131 forms a light leakage area 16.

The light source 135 is configured for emitting lights toward the light guide plate 131. The light guide plate 131 receives lights emitted by the light source 135 and guides the received lights toward a direction, so that the lights pass through the light mask layer 132 and reach the keycap area 111. Therefore, backlights are provided to the keycap area 111 to illuminate the plurality of keycaps 14 disposed on the keycap area 111, thus highlighting the characters on the plurality of keycaps 14.

The reflective layer 133 is disposed under the light guide plate 131 for reflecting lights leaving a bottom surface 1311 of the light guide plate back to the light guide plate 131. The light mask layer 132 is disposed between the baseplate 11 and the light guide plate 131. The edge of the reflective layer 133 is bound with the edge of the light mask layer 132 to form an accommodating space 15, as illustrated in FIG. 7, for accommodating the light guide plate 131.

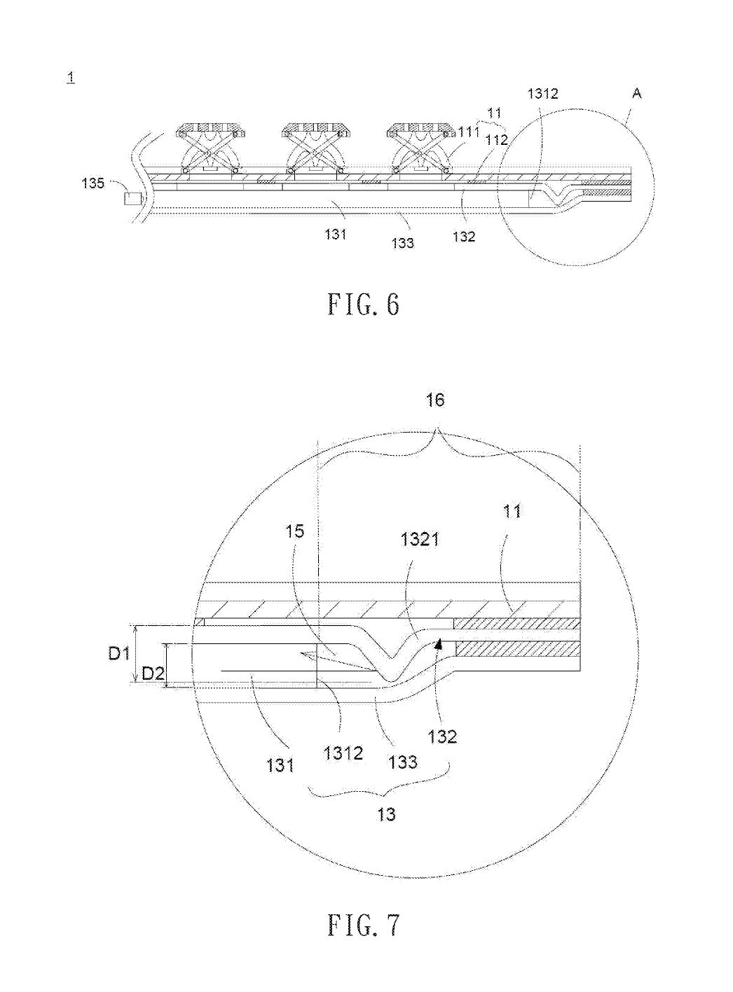

Referring now to FIG. 6 and FIG. 7. The light mask layer 132 includes a first reflective concave 1321. Cross-sectional shape of the first reflective concave 1321 may be, but is not limited to, V-shaped or U-shaped, and may be adjusted according the processing techniques.

The first reflective concave 1321 is disposed in the light shied area 16 and within the accommodating space 15. The first reflective concave 1321 pointing downward is adjacent to the lateral surface 1312 of the light guide plate 131 and may extend around the lateral surface 1312 of the light guide plate 131, as illustrated in FIG. 1. While the accommodating space 15 is configured mainly for accommodating the light guide plate 131, a subspace close to the edge of the accommodating space 15 not occupied by the light guide plate 131 is configured for accommodating the first reflective concave 1321. Cross-sectional shape of the subspace may be substantially triangular or trapezoidal, so as to ensure sufficient space for accommodating the first reflective concave 1321.

The first reflective concave 1321 is configured to reflect lights leaving the lateral surface 1312 of the light guide plate 131 toward the edges of the reflective layer 133 and the light mask layer 132 back to the light guide plate 131. More specifically, the horizontal projection of the first reflective concave 1321 corresponds to a portion of the lateral surface 1312 of the light guide plate 131. Therefore, the first reflective concave 1321 can reflect lights leaving the lateral surface 1312 back to the light guide plate 131, preventing light loss from the edges of the reflective layer 133 and the light mask layer 132 and thus enhancing the lighting intensity at the keycap area 111 of the backlit keyboard 1.

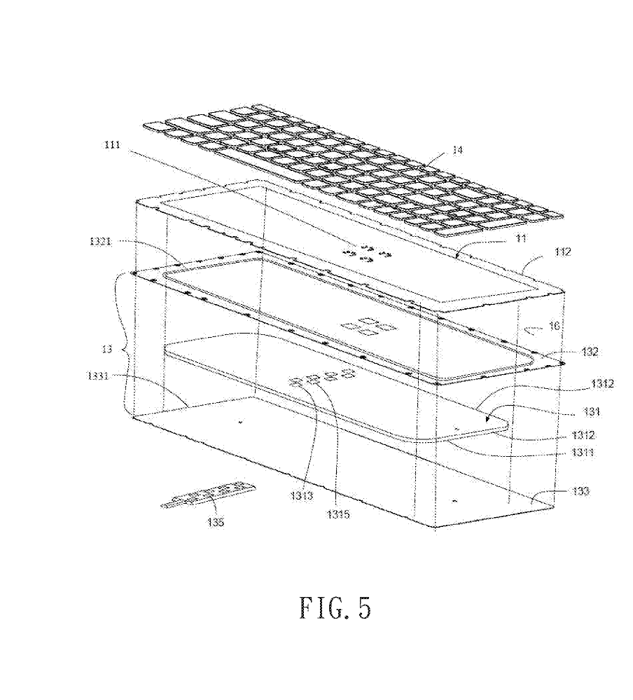

Referring now to FIG. 5. The edge of the light guide plate 131 is comprised of a plurality of lateral surfaces 1312. The light guide plate 131 includes one or more through holes 1313, and side walls of the through holes 1313 are the light incident surface 1315. The light source 135 is disposed within the through holes 1313 instead of the lateral surfaces 1312 of the light guide plate 131. The plurality of lateral surfaces 1312 of the light guide plate 131 surround the keycap area 111, making the light leakage area 16 an annular area. Therefore, the first reflective concave 1321 extends along an annular path in the light leakage area 16.

Referring again to FIG. 1 and FIG. 2. The edge of the light guide plate 131 is comprised of the light incident surface 1315 and a plurality of lateral surfaces 1312. The first reflective concave 1321 extends around the plurality of lateral surfaces 1312 but not the light incident surface 1315, thus causing the first reflective concave 1312 to extend along a substantially opened annular path. The opened annular path may be an L-shaped path or a U-shaped path.

The first reflective concave 1312 extends around the edge of the light mask layer 132. As illustrated in FIGS. 1, 3 and 4, the extension path of the first reflective concave 1321 includes a first straight line 13211, a second straight line 13212 and a curved line 13213. The extension of the first straight line 13211 is orthogonal to the extension of the second straight line 13212, and the curved line 13213 connects the first straight line 13211 to the second straight line 13212.

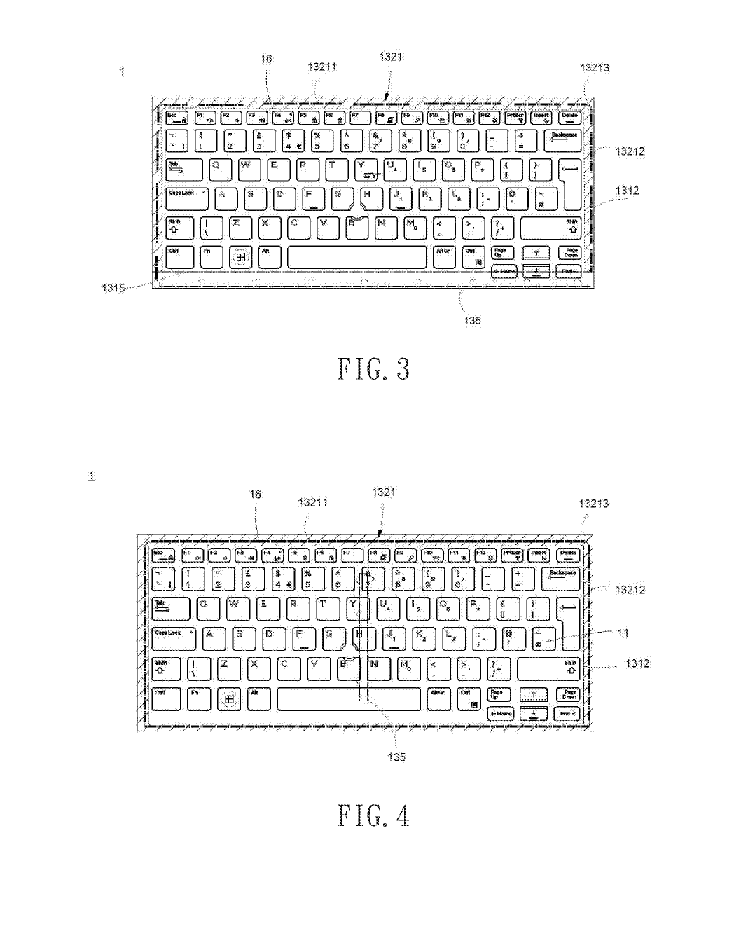

To reduce light loss from the lateral surface 1312 of the light guide plate 131, the first reflective concave 1321 may extend around the edge of the light mask layer 132 continuously, as in FIG. 1, or non-continuously, as in FIG. 3. As illustrated in FIG. 1, the length of horizontal extension of the first reflective concave 1321 may be longer than the length of horizontal extension of the lateral surface 1312 of the light guide plate 131. As illustrated in FIG. 7, the vertical length D1 of the first reflective concave 1321 may be longer than a half of the vertical length D2 of the lateral surface 1312 of the light guide plate 131; in other words, the depth of the first reflective concave 1321 may larger than a half of the thickness of the light guide plate 131.

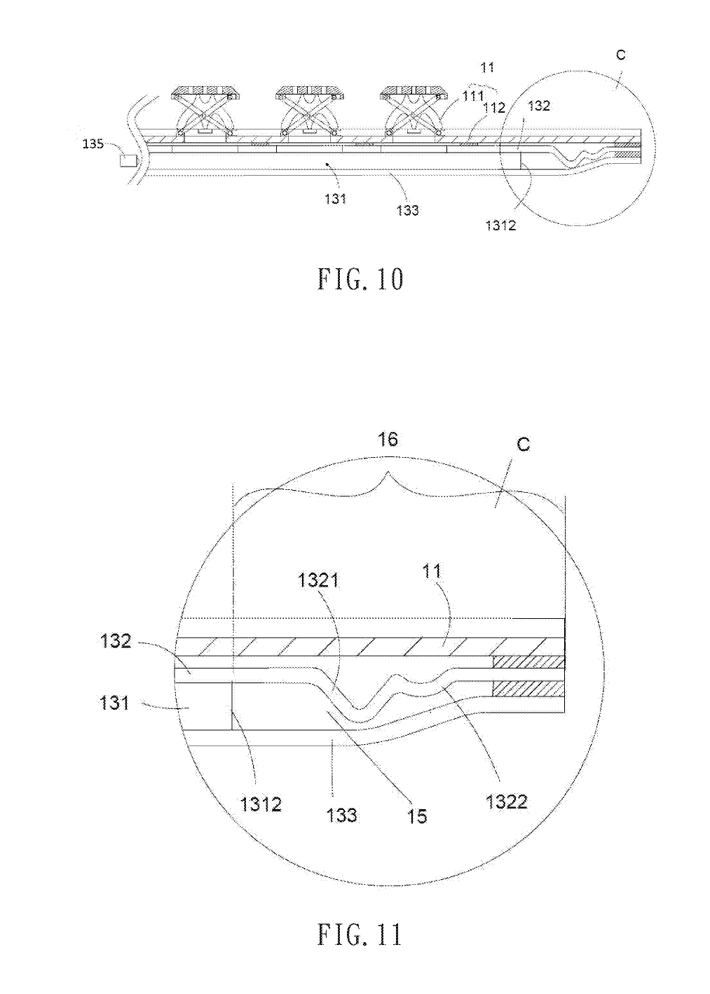

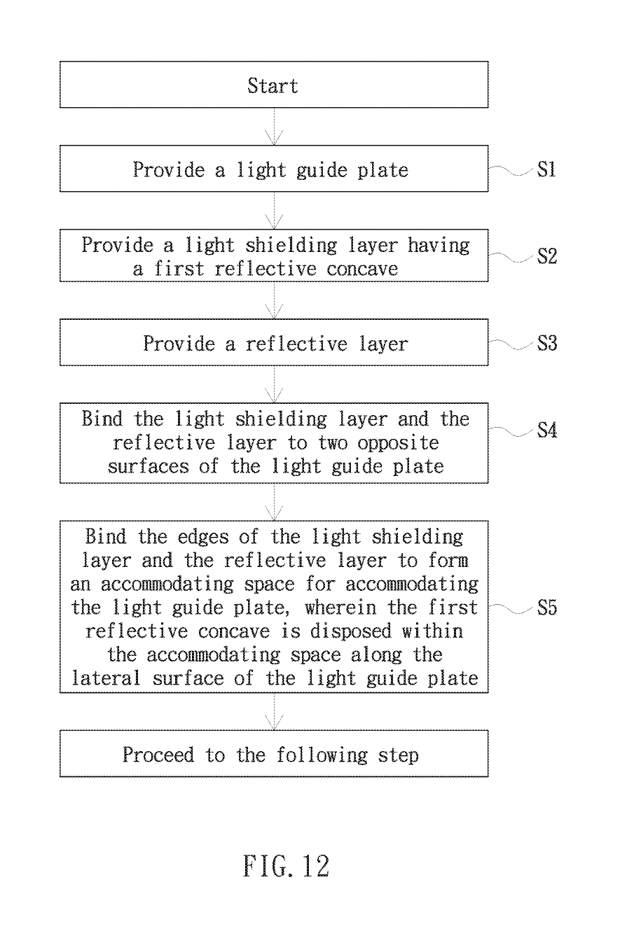

Referring now FIG. 10 and FIG. 11. The light mask layer 132 may further include a second reflective concave 1322 pointing downward and formed around the lateral surface 1312 of the light guide plate 131 and the first reflective concave 1321 in the light leakage area 16. The second reflective concave 1322 is spaced apart from the first reflective concave 1321, and can function in conjunction with the first reflective concave 1321 to reflect a portion of lights leaving the lateral surface 1312 back to the light guide plate 131. Preferably, the second reflective concave 1322 extends along the first straight line 13211, the second straight line 13212 and the curved line 13213; in other words, the second reflective concave 1322 may also extend along an annular path, an L-shaped path, or a U-shaped path.

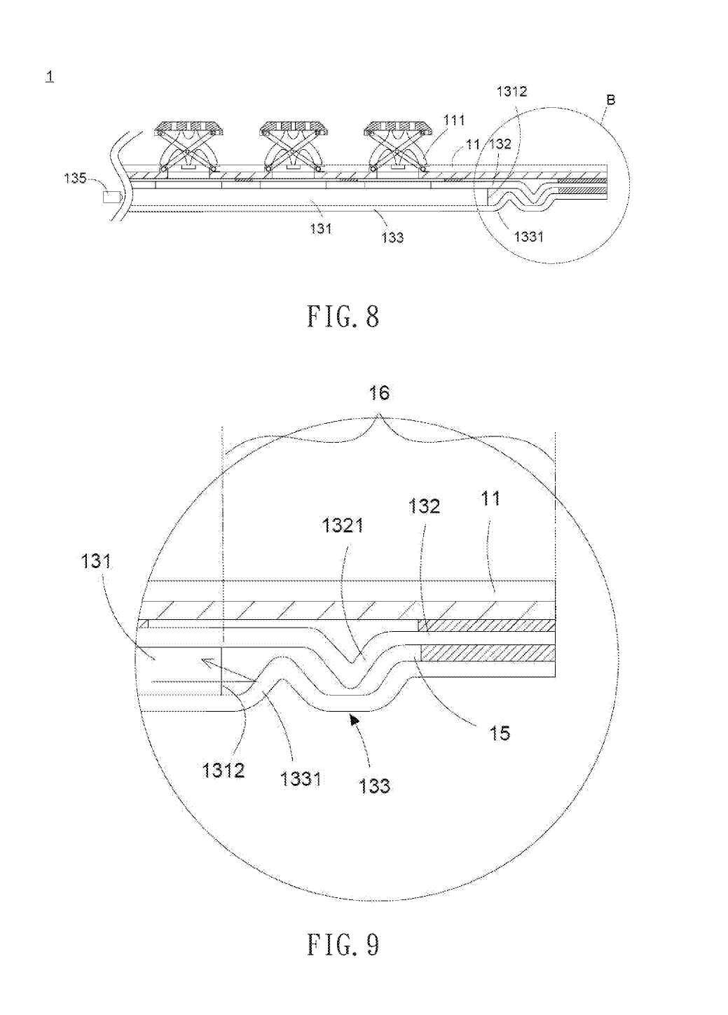

Furthermore, as illustrated in FIG. 8 and FIG. 9, the reflective layer 133 may also form a first reflective convex 1331 pointing upward and extending toward the light mask layer 132 and around the lateral surface 1312 of the light guide plate 131 and the first reflective concave 1321 within the accommodating space 15 in the light leakage area 16. The first reflective convex 1331 is spaced apart from the first reflective concave 1321 and adjacent to the lateral surface 1312 of the light guide plate 131. The first reflective convex 1331 can function in conjunction with the first reflective concave 1321 to reflect lights leaving the lateral surface 1312 toward the edges of the reflective layer 133 and the light mask layer 132 back to the light guide plate 131. Preferably, the first reflective convex 1331 extends along the first straight line 13211, the second straight line 13212 and the curved line 13213; in other words, the first reflective convex 1331 may also extend along an annular path, an L-shaped path, or a U-shaped path.

Optionally, the sum of the depth of the first reflective concave 1321 and a height of the first reflective convex 1331 is larger than the vertical length of the lateral surface 1312 of the light guide plate 131; in other words, the sum of the depth of the first reflective concave and a height of the first reflective convex may be larger than the thickness of the light guide plate.

Referring now to FIG. 11, which illustrates the assembly method of the backlight module 13 according to the embodiments of the present invention. In Steps S1 through S3: a light guide plate, a light mask layer and a reflective layer are provided. The light mask layer has a first reflective concave formed around the edge of the light mask layer by embossing or bending. Thereafter, in Step S4, the light mask layer is bound onto a top surface of the light guide plate and the reflective layer is bound onto a bottom surface of the light guide plate. Finally, in Step S5, the edge of the reflective layer is bound with the edge of the light mask layer to form an accommodating space for accommodating the light guide plate, and the first reflective concave of the light mask layer is disposed around the lateral surface of the light guide plate within the accommodating space.

In Step S3, the first reflective convex may be formed by embossing or bending the reflective layer upward and disposed around the lateral surface of the light guide plate and the first reflective concave within the accommodating space.

In sum, the present invention provides a backlit keyboard having a baseplate and a backlight module. According to the embodiments of the present invention, the backlight module of the backlit keyboard utilizes a reflective concave formed by the light mask layer along the lateral surface of the light guide plate to reflect lights leaving the lateral surface of the light guide plate back to the light guide plate, therefore preventing light loss from the lateral sides of the backlit keyboard and ensuring the lighting efficiency of the keycaps on the backlit keyboard.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A backlit keyboard, comprising:
a baseplate;
a light guide plate, disposed under the baseplate, the light guide plate having a light incident surface, a bottom surface, and a lateral surface;
a light source, configured for emitting lights toward the light guide plate, wherein the lights enter the light guide plate via the light incident surface and are transmitted through the light guide plate;
a reflective layer, disposed under the light guide plate for reflecting lights leaving the bottom surface back to the light guide plate; and
a light mask layer, disposed between the baseplate and the light guide plate, wherein the light mask layer forms a first reflective concave pointing downward and extending around the lateral surface of the light guide plate, and a portion of the lateral surface horizontally projects on the first reflective concave, thus allowing the first reflective concave to reflect lights leaving the lateral surface of the light guide plate back to the light guide plate, wherein the first reflective concave is a substantially U-shaped reflective concave.

2. A backlight module for providing backlights to at least one keycap area of a backlit keyboard, the backlight module comprising:
a light guide plate, for transmitting lights entering the light guide plate so as to provide the backlights to the keycap area;
a light mask layer, disposed on the light guide plate; and
a reflective layer, disposed under the light guide plate for reflecting lights leaving a bottom surface of the light guide plate back to the light guide plate,
wherein an edge of the reflective layer binds with an edge of the light mask layer to form an accommodating space for accommodating the light guide plate, the light mask layer forms a first reflective concave pointing downward and extending toward the reflective layer and around the lateral surface of the light guide plate within the accommodating space, and a portion of the lateral surface horizontally projects on the first reflective concave, thus allowing the first reflective concave to reflect lights leaving the lateral surface of the light guide plate back to the light guide plate, wherein the first reflective concave is a substantially U-shaped reflective concave.

3. The backlight module according to claim 2, wherein the reflective layer forms a first reflective convex around the lateral surface of the light guide plate and the first reflective concave within the accommodating space, for reflecting lights leaving the lateral surface of the light guide plate back to the light guide plate.

4. The backlight module according to claim 2, wherein the first reflective concave extends around the edge of the light mask layer and forms an extension path that is substantially rectangular in shape.

5. The backlight module according to claim 4, wherein the extension path of the first reflective concave comprises a first straight line, a second straight line and a curved line, the first straight line is orthogonal to the second straight line, and the curved line connects the first straight line to the second straight line.

6. The backlight module according to claim 4, wherein the first reflective concave extends around the edge of the light mask layer continuously or non-continuously.

7. The backlight module according to claim 2, wherein a cross-section of a subspace within the accommodating space for accommodating the first reflective concave is substantially triangular or trapezoidal in shape.

8. An assembly method of a backlight module, comprising the steps of:
providing a light guide plate;
providing a light mask layer having a first reflective concave around an edge of the light mask layer;
providing a reflective layer;
binding the light mask layer onto a top surface of the light guide plate and the reflective layer onto a bottom surface of the light guide plate; and
binding an edge of the reflective layer with an edge of the light mask layer to form an accommodating space for accommodating the light guide plate, and disposing the first reflective concave of the light mask layer pointing downward and extending around a lateral surface of the light guide plate within the accommodating space,
wherein the first reflective concave is a substantially U-shaped reflective concave.

9. The assembly method according to claim 8, wherein the reflective layer comprises a first reflective convex formed around the edge of the reflective layer and disposed between the lateral surface of the light guide plate and the first reflective concave within the accommodating space.

10. The assembly method according to claim 9, wherein the first reflective concave and the first reflective convex are formed by embossing or bending.

11. A backlit keyboard, comprising:
a plurality of keycaps;
a baseplate, having a peripheral area and a keycap area, the plurality of keycaps disposed within the keycap area;
a light guide plate, disposed beneath the keycap area of the baseplate, the light guide plate having a light incident surface, a bottom surface, and a lateral surface, wherein an area under the peripheral area of the baseplate and over the lateral surface of the light guide plate forms a light leakage area;
a light source, emitting lights toward the light guide plate, wherein the lights enter the light guide plate via the light incident surface and are transmitted through the light guide plate to reach the keycap area;
a reflective layer, disposed under the light guide plate for reflecting lights leaving the bottom surface back to the light guide plate; and
a light mask layer, disposed between the baseplate and the light guide plate, wherein the light mask layer forms a first reflective concave pointing downward and extending around the lateral surface of the light guide plate within the light leakage area, and a portion of the lateral surface horizontally projects on the first reflective concave, thus allowing the first reflective concave to reflect lights leaving the lateral surface of the light guide plate back to the light guide plate, wherein the first reflective concave is a substantially U-shaped reflective concave.

12. The backlit keyboard according to claim 11, wherein a length of horizontal extension of the first reflective concave is longer than a length of horizontal extension of the lateral surface of the light guide plate.

13. The backlit keyboard according to claim 11, wherein a vertical length of the first reflective concave is longer than a half of a vertical length of the lateral surface of the light guide plate.

14. The backlit keyboard according to claim 11, wherein the peripheral area of the baseplate comprises a plurality of lateral sides extending around the keycap area, thus making the light leakage area an annular area, and the first reflective concave extending along an annular path in the light leakage area.

15. The backlit keyboard according to claim 14, wherein an edge of the light guide plate comprises a plurality of lateral surfaces, the light guide plate comprises a through hole, a side wall of the through hole is the light incident surface, thus allowing the first reflective concave to extend along a substantially closed annular path around the plurality of lateral surfaces of the light guide plate.

16. The backlit keyboard according to claim 11, wherein an edge of the light guide plate comprises the light incident surface and a plurality of lateral surfaces, the first reflective concave extends around the plurality of lateral surfaces but not the light incident surface, thus allowing the first reflective concave to extend along a substantially opened annular path, wherein the opened annular path is an L-shaped path or a U-shaped path.

17. The backlit keyboard according to claim 11, wherein an edge of the reflective layer binds with an edge of the light mask layer to form an accommodating space for accommodating the light guide plate, and the first reflective concave is disposed within the accommodating space.

18. The backlit keyboard according to claim 11, wherein the reflective layer forms a first reflective convex around the lateral surface of the light guide plate and the first reflective concave in the light leakage area.

19. The backlit keyboard according to claim 18, wherein a sum of a depth of the first reflective concave and a height of the first reflective convex is larger than a thickness of the light guide plate.

20. The backlit keyboard according to claim 11, wherein the light mask layer further forms a second reflective concave around the lateral surface of the light guide plate and the first reflective concave in the light leakage area.
